(19) United States
(12) Patent Application Publication
(10) Pub. No.: US 2025/0365133 A1
(43) Pub. Date: Nov. 27, 2025

(54) HIGH PERFORMANCE, VALUESAMPLESPACE, EQUALIZED PRN DATA OBFUSCATION

(71) Applicant: William David Schwaderer, Sparks, NV (US)

(72) Inventor: William David Schwaderer, Sparks, NV (US)

(21) Appl. No.: 19/219,878

(22) Filed: May 27, 2025

Related U.S. Application Data
(60) Provisional application No. 63/651,829, filed on May 24, 2024.

(51) Int. Cl. H04L 9/06

(52) U.S. Cl. CPC H04L 9/0662

(57) ABSTRACT

Embodiments are generally directed to a data obfuscation method that has access to a plurality-dimensioned ValueSampleSpace, a multiplicity of ValueSampleSpace ElementTransitionStrategies, and a multiplicity of ValueSampleSpace SamplingStrategies, where each ValueSampleSpace element holds a plurality of data bit values. A suitably plurality-dimensioned array with each element holding a plurality of data bit values can represent a plurality-dimensioned ValueSampleSpace, though other ValueSampleSpace representations are within the scope of the present disclosure.

### CROSS REFERENCE TO RELATED APPLICATIONS

The present application claims priority to U.S. Provisional Application No. 63/651,829, entitled “HIGH PERFORMANCE, VALUESAMPLESPACE, EQUALIZED PRN DATA OBFUSCATION”, and filed on May 24, 2024. The entire contents of the above-listed application are hereby incorporated by reference for all purposes.

### BACKGROUND AND SUMMARY

Data encryption is an important element to systems attempting to provide data privacy. This invention provides high performance data encryption combining existing and new methods in novel ways to produce new, unsurpassed protection and safety. In this invention, a data obfuscation method has access to a plurality-dimensioned ValueSampleSpace, a multiplicity of ValueSampleSpace ElementTransitionStrategies, and a multiplicity of ValueSampleSpace SamplingStrategies.

Each ValueSampleSpace element holds a plurality of data bit values.

Programmatically, a suitably plurality-dimensioned array with each element holding a plurality of data bit values can represent a plurality-dimensioned ValueSampleSpace. Other ValueSampleSpace representations are possible. This example representation is not meant to be limiting.

Referencing a starting, “current” ValueSampleSpace element determined by any means, with an optional ElementCounter initialized to zero, the data obfuscation method identifies a new current element by any means within the ValueSampleSpace to reference using one of the multiplicity of ElementTransitionStrategies available to the method. In data communication applications, the starting ValueSampleSpace element can be identified in whole, or in part, using a Multi Factor Authentication (MFA) message exchange.

The specific ElementTransitionStrategy used can be algorithmically identified using the previous (initially, the starting element) element's plurality of data bits and, optimally, the optional ElementCounter value. Other ElementTransitionStrategy identification means are possible. This example identification means is not meant to be limiting.

The optional ElementCounter value is incremented to indicate the data obfuscation method now references a new, current element.

Referencing the newly identified, current, element, using one of a plurality of SamplingStrategies available to the method and selected by any means, the method samples ValueSampleSpace element bit values held by an strategy-identified loci of ValueSampleSpace array elements the SamplingStrategy identifies with respect to the current element. The specific SamplingStrategy used can be algorithmically identified using the previous element's plurality of data bits and, optimally, the optional ElementCounter value. Other SamplingStrategy identification means are possible. This example identification means is not meant to be limiting.

The data obfuscation method now references a new, current ValueSampleSpace element using similar process as it used to transition to the currently referenced ValueSampleSpace element. This process continues until a required number sample values have been generated, resulting in a first pseudo random number bit sequence of any required size.

The data obfuscation method now uses the collective sample values, or derivative values generated from them, to initialize a Pseudo Random Number Generator means of any type or form. The data obfuscation method can also use the collective sample values to determine how to warm up the initialized Pseudo Random Number Generator means of any type or form.

The data obfuscation method now has the Pseudo Random Number Generator means of any type or form generate a plurality of Pseudo Random Numbers and uses them, or values derived from them, to populate a data buffer means. The data obfuscation method then identifies by any means an equalization UnitSize such that the UnitSize reflects the number of data bits contained within an associated Unit type. For example, selecting a UnitSize equal to 2, results in a 2-bit UnitType with UnitType values of ‘00’, ‘01’, ‘10’, and ‘11’. Other UnitSizes are possible. This example UnitSize value of 2 is not meant to be limiting.

The data obfuscation method now optionally performs an inventory of the UnitType values within the Pseudo Random Number Generator populated data buffer means and determines the multiplicity of each type UnitType value that would make the UnitType value counts equal when blended with the Pseudo Random Number Generator populated data buffer values. This usually creates a larger buffer retention means requirement to hold the collective blended result, though blending analysis can occur simultaneously with each newly generated PRN.

UnitType Blending is performed using any of many pseudo random driven blending method know to practitioners skilled in the art. For example, a Fisher-Yates blending utilizing values supplied by the Pseudo Random Number Generator means of any type or form. Other blending means are possible. The example Fisher-Yates blending means is not meant to be limiting.

The previous steps have generated a second pseudo random number bit sequence of any required size.

The data obfuscation method now accesses by any means familiar to practitioners skilled in the art plaintext data requiring obfuscation. Using the values within the second pseudo random number bit sequence, the data obfuscation method performs carry-less add operations of any bit-width with plaintext bit addends of the same size to generate ciphertext sum values that collectively that obfuscate the plaintext. Carry-less add operations bit widths can be uniform or vary by any determined means.

The data obfuscation method next optionally subdivides the obfuscated plaintext ciphertext into Segments of any size and count. The collective Segments are non-overlapping, mutually exclusive, and collectively exhaustive. The data obfuscation method then optionally creates a pseudo randomized Vectored IO Scatter Gather list that enables the data obfuscation method to direct a system Input Output Processor (IOP) to save the Segments to a data retention means or data transmission means in an out of order sequence described by the Vectored IO Scatter Gather list. Optimally, the IOP utilizes a Direct Memory Access Means that does not otherwise require a processor involvement in Segment movements.

The data obfuscation method saves or delivers generated ciphertext to a transmission means.

Decryption means simply reverse encryption steps by constructing and using the same Pseudo Random Number Generator and Pseudo Random Number values it produces.

It will be appreciated that, in certain embodiments, a data de-obfuscation method can be used to recover original plaintext by reversing the described obfuscation steps in a reverse order.

### BRIEF DESCRIPTION OF THE DRAWINGS

FIG. 1 shows a generated first random bit sequence initializes a Pseudo Random Number Generator (PRNG), enabling it to generate Pseudo Random Number (PRN) values that are further processed in accordance with certain embodiments of the present disclosure.

FIG. 2 provides an explanation of how the first random bit sequence is generated in accordance with certain embodiments of the present disclosure.

FIG. 3 shows how the generated first random bit sequence initializes an example, non-limiting PRNG in accordance with certain embodiments of the present disclosure.

FIG. 4 shows how the output from the example, non-limiting PRNG is further processed to generate a second random bit sequence in accordance with certain embodiments of the present disclosure.

FIG. 5 shows how second random bit sequence example Unit Size values are equalized and the Unit equalization values are blended onto the second random bit sequence on a Unit basis in accordance with certain embodiments of the present disclosure.

FIG. 6 provides a non-limiting example of how the blended equalized second random bit sequence can be used to encrypt plaintext data in accordance with certain embodiments of the present disclosure.

### DETAILED DESCRIPTION

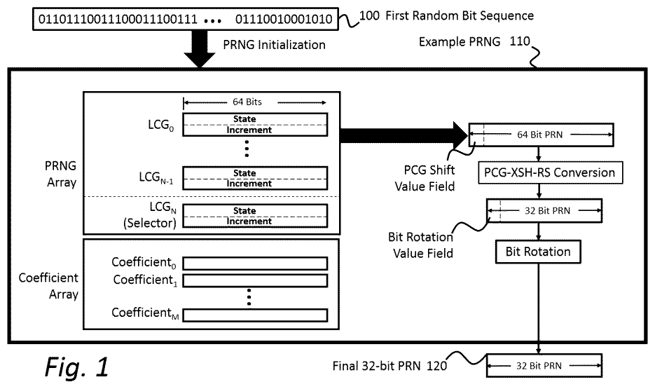

In FIG. 1, a generated First Random Bit Sequence 100 initializes an example, non-limiting PRNG 110. Following discussion describes the Example PRNG which generates PRNs 120 for use by other invention components.

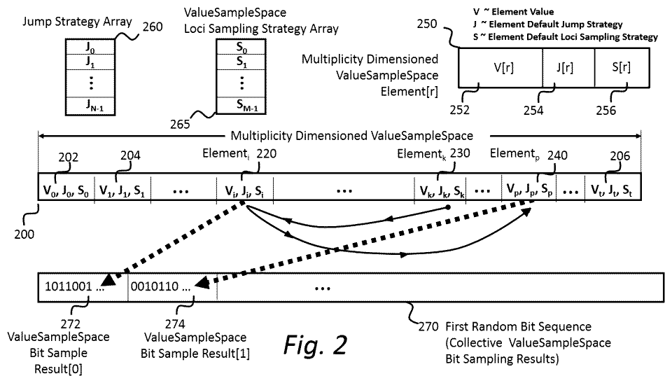

FIG. 2 illustrates a multiplicity-dimensioned ValueSampleSpace 200 the invention samples to generate a First Random Bit Sequence 270. Programmatically, the ValueSampleSpace 200 is a multi-dimensional array with a multiplicity of sample space elements. For non-limiting discussion simplicity, the ValueSampleSpace 200 dimension is one.

Each ValueSampleSpace 200 element 250 has three associated fields: (1) an Element Value 252, (2) an optional default jump strategy 254, and (3) an optional default sampling strategy 256.

In the simplistic non-limiting example, the Multiplicity Dimensioned ValueSampleSpace 200 Elements are sequentially accessible. In FIG. 2, a compliant representation is Element 0 202, Element 1 204, . . . Element i 220, . . . , Element k 230, Element p 240, and Element t 206.

When a default optional Default Jump Strategy 254 is not used, one can be selected from a Jump Strategy Array 260 using any selection means. When an optional Default Sampling Strategy 256 is not used, one can be selected from a ValueSampleSpace Loci Sampling Strategy Array 265 using any selection means.

In FIG. 2, the invention determines a Multiplicity ValueSampleSpace 200 element starting position by any means including Multi Factor Authentication (MFA) messaging. In FIG. 2, the starting position is Element k 230. Using the jump strategy associated with Element k 230, a new position is identified. In this example, the new position is Element i 220. At Element i 220, the invention samples bit values for ValueSampleSpace 200 elements loci according to the sampling strategy at the previous location (Element k 230) or some other identified sampling strategy. The invention algorithmically processes and aggregates the sample values to produce a ValueSampleSpace Bit Sample Result[0] 272 which it retains in a First Random Bit Sequence 270 for later use.

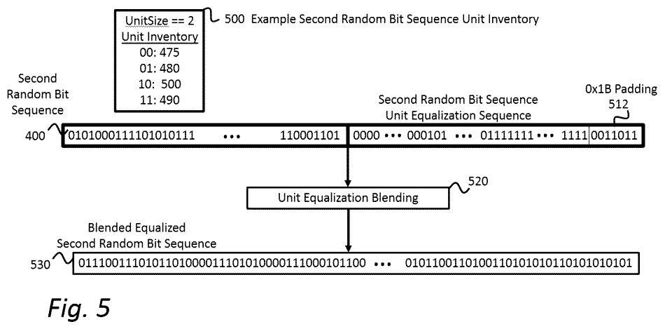

Using the jump strategy associated with Element i 220, a new position is identified. In this example, the new position is Element p 240. At Element p 240, the invention samples bit values for ValueSampleSpace 200 elements loci according to the sampling strategy at the previous location (Element i 220) or some other identified sampling strategy. The invention algorithmically processes the sample values to produce a ValueSampleSpace Bit Sample Result[1] 274 which it retains in a First Random Bit Sequence 270 for later use. The process continues until First Random Bit Sequence 270 contains a desired number of bit values. Equalization unit inventory analysis discussed in FIG. 5 can occur with every newly generated PRN.

It is to be understood that Multiplicity ValueSampleSpace 200 could be generated or otherwise obtained in any manner. Specifically, Multiplicity ValueSampleSpace 200 could be the final calculation result of a Diffie-Hellman or other discrete logarithm based secret key derivation, an Elliptic Curve public encryption key, a public RSA encryption key, a public McEliece encryption key, a public Lattice encryption key, any public asymmetric encryption key, atmospheric noise sample values, a True Random Number bit sequence, an output sequence from a quantum mechanical electron tunneling device, any bit sequence that has been equalized as described in FIG. 5, etc. Moreover, the First Random Bit Sequence 270 can also be equalized as described in FIG. 5, before it is further used.

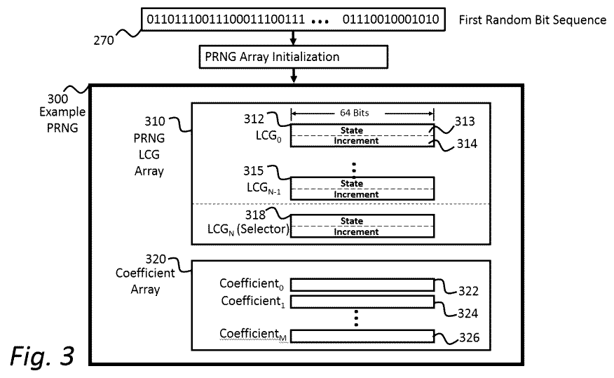

In FIG. 3, First Random Bit Sequence 270 initializes a PRNG of any type. In a non-limiting PRNG example, the PRNG is an array of 64-bit Linear Congruential Generators (LCGs) 300. As appreciated by practitioners skilled in the art, any LCG has a State, Coefficient, and Increment. In PRNG 300, the LCG Coefficients 322, 324, and 326 are separated from the LCGs 312, 315, and 318. This decouples the LCG Coefficients 322, 324, and 326 from LCG 312, 315, and 318 States and Increments, allowing any LCG Coefficient 322, 324 to be used in any 64-bit PRN computation.

One LCG, LCG[N] 318, is a selector LCG that can determine which LCG 312, 315 and which LCG Coefficient 322, 324 generates a PRN.

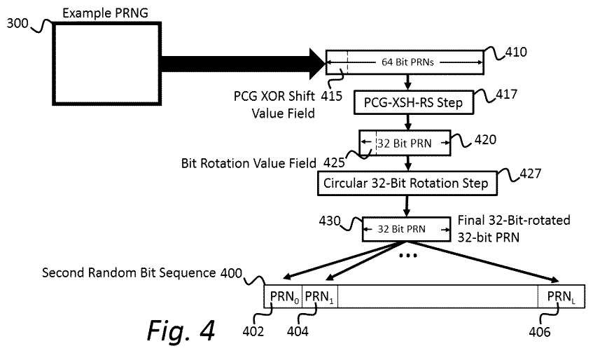

FIG. 4 illustrates how Example PRNG 300 produces 64-bit PRN values 410 the invention further permutes (processes). Each 64-bit PRN 410 has a Permuted Congruential Generator (PCG) XOR Shift Field Value Field 415 that is evaluated to perform a 64-bit PCG-XSH-RS operation 417 to produce a 32-bit PRN 420. 32-bit PRN 420 has a Bit Rotation Value Field that is evaluated to perform a 32-bit circular rotation operation to produce a 32-bit-Rotated PRN 430 which is retained in a Second Random Bit Sequence 400 retention buffer as a Second Random Bit Sequence 400 element 402, 404, . . . 406. The process continues until Second Random Bit Sequence 400 contains a desired number of bit values.

In FIG. 5, Second Random Bit Sequence 400, two-bit values are equalized. Here, a two-bit Unit Size is selected. A Unit Size of 1 requires a one-bit equalization operation. A Unit Size of 2 requires a two-bit equalization operation, etc. To equalize Second Random Bit Sequence 400 values, an inventory of Unit Types is performed. FIG. 5 illustrates a two-bit Unit Size and a simple example Unit inventory 500.

In this example, equalizing two-bit Second Random Bit Sequence 400 values requires appending 25 ‘00’ Units, 20 ‘01’ Units, no ‘10’ Units (since it has the maximum inventory count), and 10 ‘11’ Units. To add additional Units and retain equalization requires adding hexadecimal 0x1B bytes 512. Step 520 next uses any method known to practitioners skilled in the art to blend the appended Units into the Second Random Number Bit Sequence as bit pair Units in order to achieve Unit equalization. This creates a Blended Equalized Second Random Bit Sequence 530.

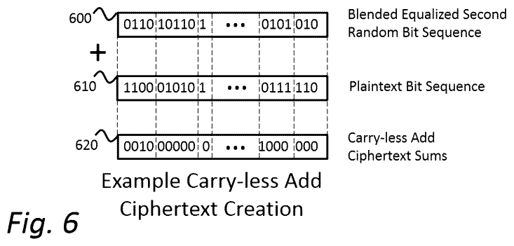

FIG. 6 illustrates how the invention can use Blended Equalized Second Random Bit Sequence 530 to encrypt plaintext data. As a non-limiting encryption example, Blended Equalized Second Random Bit Sequence 530 is carry-less added to plain text data to create cyphertext. Carry-less add operations can be of any bit-width and larger bit widths introduce plaintext bit-value diffusion through internal ordinary binary addition carry events. Carry-less add operations can be of uniform width, fixed width or varying width with operation widths determined by any means.

### EXAMPLES

In certain examples, a computer-implemented method can include: using a multiplicity algorithmic ValueSampleSpace element transitioning means and a ValueSampleSpace sampling means to generate a first pseudo random sampled bit sequence from a multiplicity-dimensioned ValueSampleSpace; and using the first pseudo random ValueSampleSpace sampled bit sequence values to initialize or warm up a Pseudo Random Number Generator means.

The computer-implemented method can further include using the Pseudo Random Number Generator means to generate a second pseudo random bit sequence.

The computer-implemented method can further include equalizing the UnitTypes of pseudo random bit sequence values in the second pseudo random bit sequence a Pseudo Random Number Generator means generated to use to create ciphertext from plaintext.

The computer-implemented method can further include pseudo randomly blending identified equalization Units into the second pseudo random bit sequence values.

The computer-implemented method can further include using blended pseudo random bit sequence values as addends in carry-less add operations of any bit width with plaintext addends to create ciphertext.

The computer-implemented method can further include segmenting created ciphertext into non-overlapping, mutually exclusive, and collectively exhaustive Segments.

The computer-implemented method can further include saving the collectively exhaustive Segments to a data retention means or data transmission means in an out of order sequence described by a Vectored IO Scatter Gather list using pseudo random numbers generated by a Pseudo Random Number Generator means.

The computer-implemented method can further include sending the collectively exhaustive Segments to a data retention means, data transmission means utilizing a DPU or other offload mechanism that does not otherwise require a processor involvement in Segment movements, or recipient entity utilizing an IOP with a Direct Memory Access Means that does not otherwise require a processor involvement in Segment movements.

In certain embodiments, the starting ValueSampleSpace element is identified in whole, or in part, using a Multi Factor Authentication (MFA) message exchange.

In certain embodiments, the starting ValueSampleSpace includes a RSA public key bit sequence, a computational derivation of a RSA public key bit sequence, a McEliece public key bit sequence, or a computational derivation of a McEliece public key bit sequence, in whole or in part.

In certain embodiments, the ValueSampleSpace has been equalized before sampling.

In certain embodiments, the first pseudo random ValueSampleSpace sampled bit sequence has been equalized before its use.

The computer-implemented method can further include segmenting plaintext into non-overlapping, mutually exclusive, and collectively exhaustive plaintext Segments for independent encrypting operations.

In certain embodiments, the encrypting operations use independent processor cores to perform concurrent encryption operations.

In certain embodiments, the collectively exhaustive plaintext Segments are assigned to independent processor cores using processor affinity assignment methods.

In certain embodiments, the starting ValueSampleSpace includes an Elliptic Curve encryption public key bit sequence, or a computational derivation of an Elliptic Curve encryption public key bit sequence, in whole or in part.

In certain embodiments, the starting ValueSampleSpace includes a Lattice encryption public key bit sequence, or a computational derivation of a Lattice encryption public key bit sequence, in whole or in part.

In certain embodiments, the starting ValueSampleSpace includes any public asymmetric encryption key bit sequence, or a computational derivation of any public asymmetric encryption key, in whole or in part.

Certain embodiments may include one or more computer-readable storage media storing computer-executable instructions that, when executed by a processor, cause the processor to perform any of the disclosed computer-implemented methods.

The data obfuscation method next optionally subdivides the obfuscated plaintext ciphertext into Segments of any size and count. The collective Segments are non-overlapping, mutually exclusive, and collectively exhaustive. The data obfuscation method then optionally creates a pseudo randomized Vectored IO Scatter Gather list that enables the data obfuscation method to direct a system Input Output Processor (IOP) to save the Segments to a data retention means or data transmission means in an out of order sequence described by the Vectored IO Scatter Gather list. Optimally, the IOP utilizes a Direct Memory Access Means that does not otherwise require a processor involvement in Segment movements.

Practitioners skilled in the art appreciate that the data obfuscation method could alternately direct a Data Processing Unit (DPU) to save the Segments to a data retention means or data transmission means in an out of order sequence described by the Vectored IO Scatter Gather list using DPU system calls. Other such offload means are possible and this invention disclosure is meant to include those as embodiment examples.

The data obfuscation method saves or delivers generated ciphertext to a transmission means, a data retention means, or other recipient entity for subsequent utilization or disposition.

Because the described method encrypts any bit sequence as an independent operation, it is to be understood that a plaintext bit sequence of any size can be encrypted by subdividing a large plaintext bit sequence into independent, non-overlapping, and mutually exclusive bit sequence segments that are collectively exhaustive in order to encrypt them independently in any order. Moreover, in multicore processing environments, such processing allows the method to assign independent segments to independent processor cores using core affinity assignment methods familiar to practitioners skilled int the art.

Aspects of the disclosure may operate on particularly created hardware, firmware, digital signal processors, or on a specially programmed computer including a processor operating according to programmed instructions. The terms controller or processor as used herein are intended to include microprocessors, microcomputers, Application Specific Integrated Circuits (ASICs), and dedicated hardware controllers.

One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device.

The computer executable instructions may be stored on a computer readable storage medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like.

Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or computer-readable storage media, which may be read and executed by one or more processors. Such instructions may be referred to as a computer program product.

Computer-readable media, as discussed herein, means any media that may be accessed by a computing device. By way of example, and not limitation, computer-readable media may comprise computer storage media and communication media.

The terminology used herein is for the purpose of describing particular embodiments only and is not intended to be limiting of any embodiment. As used herein, the singular forms “a,” “an” and “the” are intended to include the plural forms as well, unless the context clearly indicates otherwise.

It will be further understood that the terms “comprises” and/or “comprising,” when used in the present specification, specify the presence of stated features, integers, steps, operations, elements, and/or components, but do not preclude the presence or addition of one or more other features, integers, steps, operations, elements, components, and/or groups thereof. As used herein, the term “and/or” may include any and all combinations of one or more of the associated listed items.

The previously described versions of the disclosed subject matter have many advantages that were either described or would be apparent to a person of ordinary skill. Even so, these advantages or features are not required in all versions of the disclosed apparatus, systems, or methods.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the invention have been illustrated and described for purposes of illustration, it will be understood that various modifications may be made without departing from the spirit and scope of the invention.

It will be appreciated to one of ordinary skill in the art that variants of the above-disclosed and other features and functions, or alternatives thereof, may be combined into many other different systems or applications.

Various presently unforeseen or unanticipated alternatives, modifications, variations, or improvements therein may be subsequently made by those skilled in the art.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A computer-implemented method, comprising:
using a multiplicity algorithmic ValueSampleSpace element transitioning means and a ValueSampleSpace sampling means to generate a first pseudo random sampled bit sequence from a multiplicity-dimensioned ValueSampleSpace; and
using the first pseudo random ValueSampleSpace sampled bit sequence values to initialize or warm up a Pseudo Random Number Generator means.

2. The computer-implemented method according to claim 1, further comprising using the Pseudo Random Number Generator means to generate a second pseudo random bit sequence.

3. The computer-implemented method according to claim 2, further comprising equalizing the UnitTypes of pseudo random bit sequence values in the second pseudo random bit sequence a Pseudo Random Number Generator means generated to use to create ciphertext from plaintext.

4. The computer-implemented method according to claim 2, further comprising pseudo randomly blending identified equalization Units into the second pseudo random bit sequence values.

5. The computer-implemented method according to claim 4, further comprising using blended pseudo random bit sequence values as addends in carry-less add operations of any bit width with plaintext addends to create ciphertext.

6. The computer-implemented method according to claim 5, further comprising segmenting created ciphertext into non-overlapping, mutually exclusive, and collectively exhaustive Segments.

7. The computer-implemented method according to claim 6, further comprising saving the collectively exhaustive Segments to a data retention means or data transmission means in an out of order sequence described by a Vectored IO Scatter Gather list using pseudo random numbers generated by a Pseudo Random Number Generator means.

8. The computer-implemented method according to claim 7, further comprising sending the collectively exhaustive Segments to a data retention means, data transmission means utilizing a DPU or other offload mechanism that does not otherwise require a processor involvement in Segment movements, or recipient entity utilizing an IOP with a Direct Memory Access Means that does not otherwise require a processor involvement in Segment movements.

9. The computer-implemented method according to claim 1, where the starting ValueSampleSpace element is identified in whole, or in part, using a Multi Factor Authentication (MFA) message exchange.

10. The computer-implemented method according to claim 1, where the starting ValueSampleSpace includes a Diffie-Hellman exchange or other discrete logarithm based bit sequence result, or a derivation of a Diffie-Hellman or other discrete logarithm based bit sequence result.

11. The computer-implemented method according to claim 1, where the starting ValueSampleSpace includes a RSA public key bit sequence, a computational derivation of a RSA public key bit sequence, a McEliece public key bit sequence, or a computational derivation of a McEliece public key bit sequence, in whole or in part.

12. The computer-implemented method according to claim 1, where the ValueSampleSpace has been equalized before sampling.

13. The computer-implemented method according to claim 1, where the first pseudo random ValueSampleSpace sampled bit sequence has been equalized before its use.

14. The computer-implemented method according to claim 1, further comprising segmenting plaintext into non-overlapping, mutually exclusive, and collectively exhaustive plaintext Segments for independent encrypting operations.

15. The computer-implemented method according to claim 14, where the encrypting operations use independent processor cores to perform concurrent encryption operations.

16. The computer-implemented method according to claim 15, where the collectively exhaustive plaintext Segments are assigned to independent processor cores using processor affinity assignment methods.

17. The computer-implemented method according to claim 1, where the starting ValueSampleSpace includes an Elliptic Curve encryption public key bit sequence, or a computational derivation of an Elliptic Curve encryption public key bit sequence, in whole or in part.

18. The computer-implemented method according to claim 1, where the starting ValueSampleSpace includes a Lattice encryption public key bit sequence, or a computational derivation of a Lattice encryption public key bit sequence, in whole or in part.

19. The computer-implemented method according to claim 1, where the starting ValueSampleSpace includes any public asymmetric encryption key bit sequence, or a computational derivation of any public asymmetric encryption key, in whole or in part.

20. One or more computer-readable storage media storing computer-executable instructions that, when executed by a processor, cause the processor to perform the computer-implemented method according to claim 1.
